(19) United States
(12) Patent Application Publication
(10) Pub. No.: US 2004/0257402 A1
(43) Pub. Date: Dec. 23, 2004

(54) Printhead for a printer cartridge

(76) Inventors: Patrick J Lynch, Dublin (IE); David Rogers, Clonmel (IE); Roy Glenn Atkinson, Kildare (IE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/479,451

(22) PCT Filed: Jul. 13, 2001
(86) PCT No.: PCT/EP01/08160

(51) Int. Cl. B41J 2/14

(52) U.S. Cl. 347/50

(57) ABSTRACT

A printhead (30) for a printer cartridge comprises a die including a plurality of nozzles (32) and channels for admitting ink to said nozzles. A resistor network comprises a resistor (29) at each nozzle, which when energised heats and expels ink from the respective nozzle. The printhead includes a set of contact pads (33), each resistor being connected by a trace (34) to a respective contact apd of the set of contact pads. One or more of the set of contact pads (R50, ID2) is adapted to receive more than one connection (38) from a circuit (35) external to said printhead.

### FIELD OF THE INVENTION

The present invention relates to a printhead for a printer cartridge, a printer cartridge including such a printhead and a method of fabricating a printer cartridge.

### BACKGROUND OF THE INVENTION

FIG. 1 shows a known form of ink jet cartridge, for example, a HP51649G from Hewlett Packard. In this case, the cartridge 10 comprises a body 20 including three chambers (not shown) individually isolated from one another for containing different colours of ink. A plug 22 seals the body 20 and the individual chambers.

Ink from the chambers is emitted from a printhead 30 which carries three sets of nozzles 32. Each set of nozzles is arranged to spray one colour of ink and comprises 16 individual nozzles, carried in two parallel rows.

The operation of the nozzles is well known to those skilled in the art and will be explained further below. Suffice it to say that the nozzles are controlled by resistors located in the printhead, and each resistor is under the control of external printer control circuitry. This circuitry is connected to the cartridge via a series of contacts 40. The contacts 40 are located on a flexible circuit 35, and flexible circuit 35 carries traces (not visible) from the flexible circuit contacts 40 to a plurality of wire bonds (not visible), also known as beams, which in turn connect the circuit traces to printhead contact pads. In other words, the flexible circuit 35 with its contact pads 40, circuit traces and wire bonds, acts to make a connection between the contact pads of the printhead 30 and the external printer control circuitry.

It is a problem with such cartridges that the wire bonds connecting the flexible circuit to the printhead can fail due to corrosion, manufacturing defect or mishandling.

### DISCLOSURE OF THE INVENTION

According to the present invention there is provided a printhead for a printer cartridge comprising a die including a plurality of nozzles and channels for admitting ink to said nozzles, a resistor network having a resistor at each nozzle, which resistor when energised heats and expels ink from the respective nozzle, said printhead including a set of contact pads, each resistor being connected by a trace to a respective contact pad of said set of contact pads, characterised in that one or more of said set of contact pads is adapted to receive more than one connection from a circuit external to said printhead and in that said one or more contacts comprises one contact directly connected to another otherwise redundant one of said set of contact pads within said printhead to receive two contacts from said external circuit.

In a further aspect of the present invention there is provided a printer cartridge comprising a body incorporating one or more ink chambers in fluid communication with a printhead comprising a die including a plurality of nozzles and channels for admitting ink to said nozzles, a resistor network having a resistor at each nozzle, which resistor when energised heats and expels ink from the respective nozzle, said printhead including a set of contact pads, each resistor being connected by a trace to a respective contact pad of said set of contact pads, and a circuit affixed to said printer cartridge comprising a plurality of circuit traces, one end of at least some of said circuit traces being connected to respective contacts of said set of contact pads of said printhead and the other end of at least some of said circuit traces being arranged to, in use, connect to printer control circuitry characterised in that one or more of said set of contact pads is connected to more than one of said circuit traces and in that:said one or more contacts comprises one contact directly connected to another otherwise redundant one of said set of contact pads within said printhead.

In a still further aspect of the present invention there is provided a method of fabricating a printer cartridge comprising the steps of: fabricating a body incorporating one or more ink chambers; affixing a printhead to said body, said-printhead comprising a die including a plurality of nozzles and channels for admitting ink from said chambers to said nozzles, a resistor network having a resistor at each nozzle, which resistor when energised heats and expels ink from the respective nozzle, said printhead including a set of contact pads, each resistor being connected by a trace to a respective contact pad of said set of contact pads; affixing a circuit to said printer cartridge, said circuit comprising a plurality of circuit traces, one end of at least some of said circuit traces being arranged to, in use, connect to printer control circuitry; and connecting the other end of at least some of said circuit traces to respective contacts of said set of contact pads characterised in that one or more of said set of contact pads is connected to more than one of said circuit traces and in that said one or more contacts comprises one contact directly connected to another otherwise redundant one of said set of contact pads within said printhead.

Using the present invention, circuitry connected across contacts that are prone to failure can continue to operate in spite of the failure of a contact. The invention can be implemented without any changes to software controlling the printer cartridge and with relatively modest re-engineering of the printer cartridge. Also printer cartridges employing the invention can be compatible with those not employing the invention.

Preferably, the printhead includes printer cartridge identification circuitry associated with one or more contact pads and one or more of these contact pads is arranged to receive more than one trace.

The operation of printer cartridge identification circuitry is critical to the functionality of a printer cartridge. As distinct from a single nozzle resistor circuit, if this circuitry fails and printer controller circuitry cannot identify a printer cartridge, then the printer cartridge may not be operable at all, in spite of the cartridge retaining much of its ink supply. The preferred embodiment allows such identification circuitry to partially fail without causing the complete failure of the printer cartridge.

Further preferably, one of the contacts arranged to receive more than one trace comprises one contact directly connected to another otherwise redundant one of said set of contact pads within said printhead.

In this case, the minimum amount of re-engineering is required to implement and provide the benefits of the invention.

### BRIEF DESCRIPTION OF THE DRAWINGS

Embodiments of the present invention will now be described with reference to the accompanying drawings, in which:

FIG. 1 is a perspective view of a conventional ink jet cartridge;

FIG. 2 is a schematic cross-section through the front face of the cartridge of FIG. 1;

FIG. 3(a) is a plan view of a portion of a printhead for a HP51649G printer cartridge with wire bonds affixed;

FIG. 3(b) is a schematic view of the interconnections between the printhead of FIG. 3(a) and the flexible circuit for the printer cartridge;

FIGS. 4 to 7 are schematic circuits illustrating the identification circuitry employed for various models of printer cartridge;

FIG. 8(a) is a plan view of a portion of a printhead with wire bonds affixed according to a first embodiment of the invention;

FIG. 8(b) is a schematic view of the interconnections between the printhead of FIG. 8(a) and the flexible circuit for the printer cartridge;

### DESCRIPTION OF THE PREFERRED EMBODIMENTS

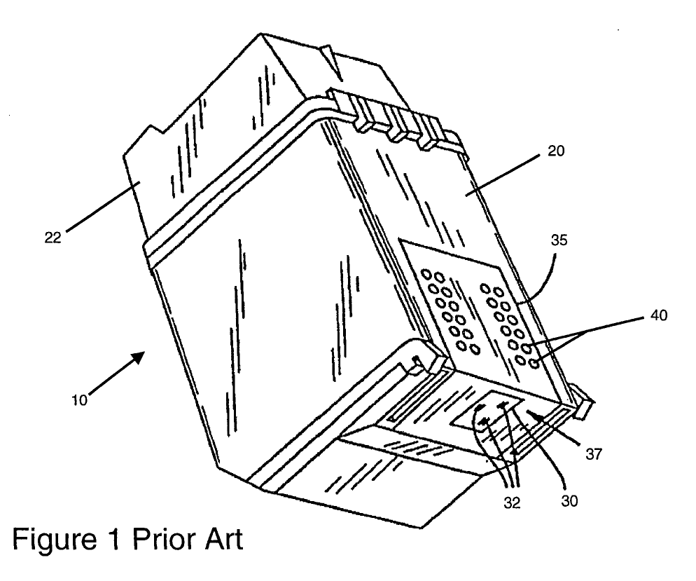

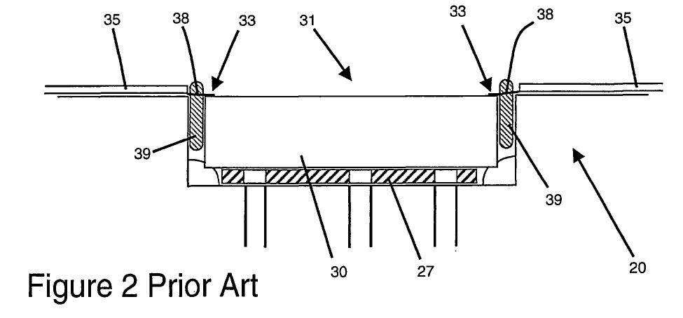

Referring now to FIG. 2 which shows in cross section a portion of the body 20 of a printer cartridge 10 of FIG. 1 in more detail. Channels lead from the chambers though openings in the base of a cavity 31 located in the front of the body 20. The printhead 30 sits on a sealing gasket 27 comprising dispensed adhesive.

Each of the three channels leads via respective openings in gasket 27, to a channel reservoir (not shown) in the printhead 30. The gasket 27 seals the printhead 30 to the body 20 and provides isolated communication for each chamber with a selected one of the channel reservoirs in the printhead. The individual nozzles of the nozzle groups 32 (FIG. 1) are in communication with the coloured ink of the respective channel reservoir and ejection of the ink from the reservoir via an individual nozzle is under the control of the relevant resistor.

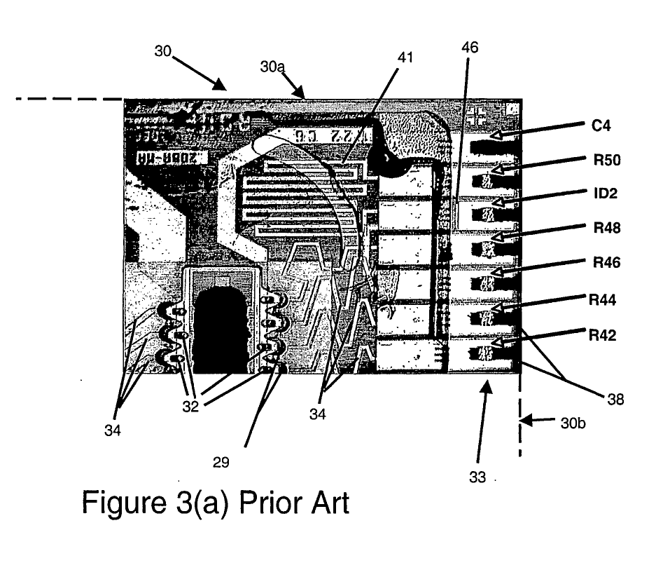

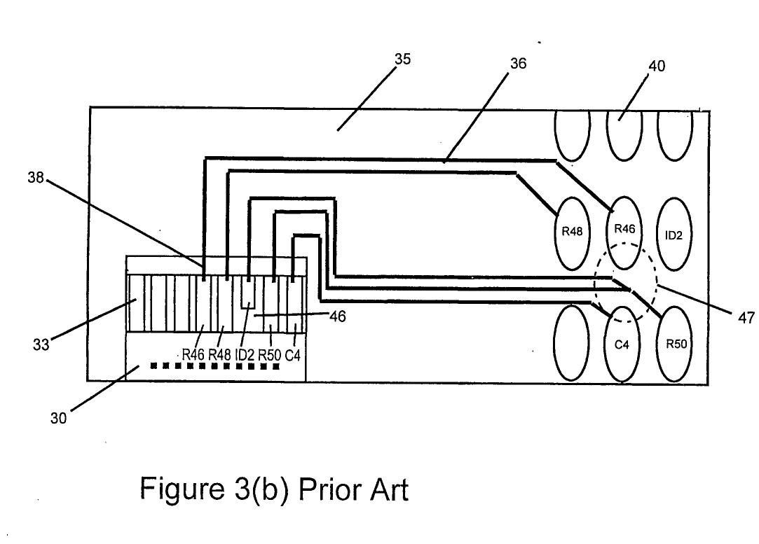

Referring now to FIG. 3(a), a corner of the printhead is shown. The corner shown is designated as the top right hand corner, in the sense that the complete printhead will extend further to the left hand side, and further down the page in the view shown, as indicated by the dashed lines which show the continuation of the top edge 30a and the right-hand edge 30b.

A series of contact pads 33 are provided down the right-hand edge 30b. Corresponding pads are on the left-hand edge (not shown). These contact pads 33 comprise: (a) resistor contact pads R1-R48 (of which R48, R46, R44 and R42 can be seen; R40, R38, R36, . . . , R2 extend further down the right-hand side, while R47, R45, . . . , R1 similarly extend down the left-hand side); (b) identification circuitry contact pads ID1, ID2 and R50 and possibly R49 (ID2 and R50 can be seen; ID1 and R49 are on the left-hand side); and (c) voltage supply contact pads C1, C2, C3, C4 (referred to also as COM1-COM4; only pad C4 is visible in FIG. 3a)).

FIG. 3a shows printhead traces 34 connecting each of the resistor contact pads R1-R48 with a corresponding resistor 29 which lies below a respective nozzle 32. During printing operations, the printer control circuitry selectively connects pads R1 to R48 to ground thus allowing current to flow from a common voltage supply (in this case C4) through the resistors 29. This causes the resistor to heat and form a gas bubble in the ink surrounding the resistor within the printhead, so causing ink to be dispensed through the nozzle 32 associated with the resistor 29.

As explained above, there are 3×16=48 individual nozzles, and each of these is controlled by one of the resistors 29, to which connection is made by one of the contact pads R1-R48. The printer control circuitry in turn is connected to each of the 48 resistor contact pads by individual contacts 40, traces and wire bonds on the flexible circuit 35.

Referring back to FIG. 1, the generally rectangular flexible circuit 35 includes an aperture 37 conforming to the outline of the printhead. The flexible circuit 35 is affixed to the cartridge by, for example, hot-melt or pressure sensitive adhesive, with the aperture surrounding the printhead 30. The flexible circuit traces traverse the flexible circuit to the side edges of the aperture 37 and extend from the flexible circuit 35 to the contact pads 33 on the printhead as wire bonds 38, which are shown in FIG. 2. The wire bonds including the gap between the side wall of the cavity 31 and the side of the printhead which the wire bonds must traverse are covered with an encapsulant 39, such as an ultra-violet cured adhesive, to prevent corrosion of the exposed wire bonds for example from chemicals in the ink being dispensed. The encapsulant also offers mechanical protection for the fragile wire bonds.

The contact pads 40 at the ends of the circuit traces on the flexible circuit 35 are also labelled in the same way as the corresponding contact pad on the printhead (i.e. R1-R50, ID1, ID2, C1-C4). These pads provide an electrical connection between the printer cartridge 10 when located on a print carriage (not shown) and printer control circuitry located off the carriage.

As mentioned above, some of the contacts (ID1, ID2, R49, R50) provided on the printhead and their corresponding contacts on the flexible circuit are employed to enable the printer control circuitry to identify the printer cartridge being employed within the printer.

In one scheme described in European Patent No. 315,417, contact pads ID1 and ID2 (designated I1 and I2 in the specification) may be connected to pads R47 or R49; and R49 or R50 respectively. The various interconnections allow 9 possible combinations and so 9 different printer cartridges can be identified using this scheme.

Of course as printer cartridges are continually developed and where there is a requirement for cartridges to be interoperable with more than one printer, there arises a requirement to extend the printer cartridge identification scheme.

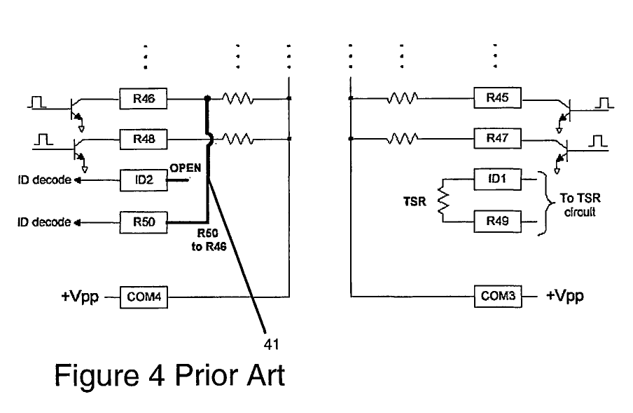

Thus, FIG. 4 shows the interconnections the printer control circuitry expects to see between the flexible circuit contact pads 40 through to the printhead for the HP51649G printer cartridge. (This circuit is also applicable to the interchangeable HP51649A printer cartridge.) In this case, contacts ID2, R46 and R50 are employed to identify the printer cartridge. The contacts R46 and R50 are connected within the printhead via a circuit trace 41, also shown in FIG. 3(a).

In order to identify the printer cartridge, the control circuitry checks to determine if contact ID2 is open circuited. The printer control circuitry also open circuits R46 and measures the voltage/current at contact R50. If this corresponds with the expected voltage drop or current across the trace 41 connecting contact R46 to R50, then the control circuitry knows the printer cartridge is indeed a model HP51649G. As an aside a further trace TSR links contact pads ID1 and R49 within the printhead. The resistance of this trace varies with temperature and by monitoring a voltage drop/current across these contacts at any time, the printer control circuitry can determine the operating temperature of the printhead.

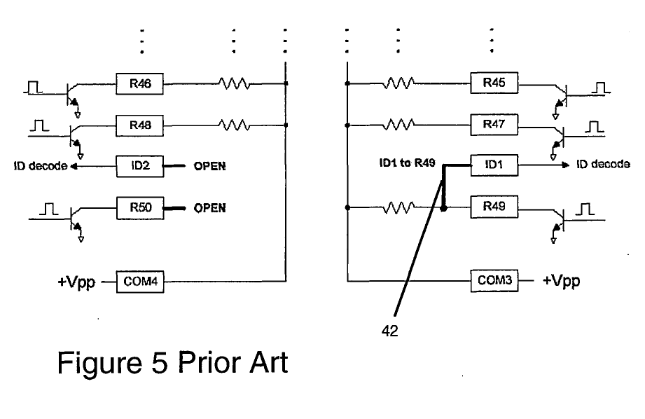

FIG. 5 shows the circuitry the printer control circuitry expects to see between the flexible circuit contact pads 40 through to the printhead for a model HP51625A printer cartridge. In this case, the printer control circuitry expects to see that the contacts ID2 and R50 are open circuited and that there is a predetermined voltage drop across the link 42 between contacts ID1 and R49. There is no printhead temperature monitoring circuitry.

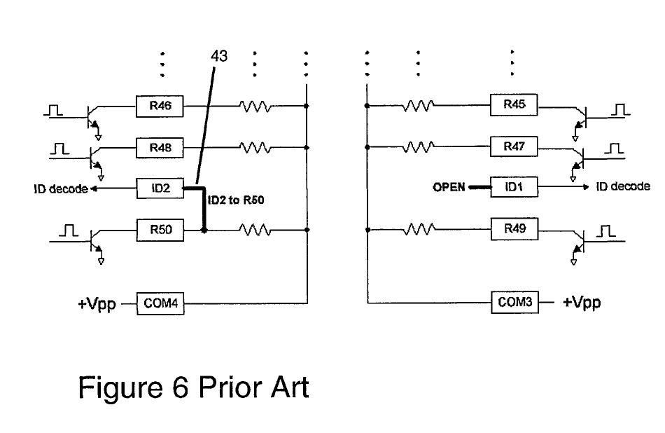

FIG. 6 shows the circuitry the printer control circuitry expects to see between the flexible circuit contact pads 40 through to the printhead for a model HP51626A printer cartridge. In this case, the printer control circuitry expects to see that there is a predetermined voltage drop across the link 43 between contacts ID2 and R50 and that the contact ID1 is open circuited. Again, there is no printhead temperature monitoring circuitry.

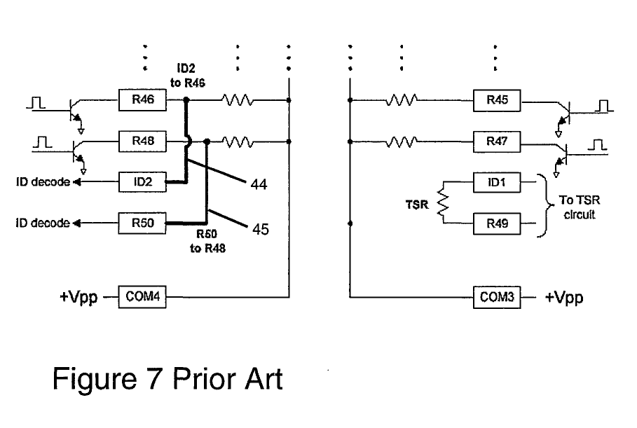

FIG. 7 shows the circuitry the printer control circuitry expects to see between the flexible circuit contact pads 40 through to the printhead for a model HP51629A printer cartridge. In this case, the printer control circuitry expects to see that there are predetermined voltage drops across the links 44 and 45 between contacts R46 and ID2; and between contacts R48 and R50 respectively. Again, a further TSR trace links contact pads ID1 and R49 within the printhead.

If other cartridges are installed, then the control circuitry could for example test other combinations of contacts to determine the model of printer cartridge.

In any case, once identified the printer control circuitry can drive the contact pads appropriately to time the dispensing of ink properly.

It will therefore be seen that the correct identification of the printer cartridge is vital in enabling a printer to function. If the identification circuitry fails, in spite of the remainder of the cartridge being functional and possibly only a fraction of the cartridge ink being used, then the printer control circuitry may not be able to operate the cartridge properly, if at all. For example, in the case of a model HP51649G, it may not be desirable, if the printer control circuitry fails to identify the model correctly, for the control circuitry simply to assume the printer cartridge is a black ink model cartridge, as the operation of such a cartridge may not be compatible with the colour cartridge.

A common cause of such a failure is due to the seal provided by the encapsulant 39 eroding and in turn exposing the wire bonds 38 to corrosion or short-circuits, FIG. 2. Because the identification circuitry is located towards the extreme ends of the printheads (i.e. in the corner as shown in FIG. 3(a)) and thus also towards the ends of the body of encapsulant, these wire bonds are most prone to attack.

However, changing the order of the contact pads or many other possible solutions to this problem would result in huge re-engineering problems requiring changes to the printhead, the flex circuitry and to printer control circuitry and software, and in any case, this may result in incompatibility between a re-designed printer cartridge and existing printer cartridges.

Referring now to FIG. 3(a), as explained above, in the case of model HP51649G printer cartridge, contact pad ID2 adjacent pad R50 is not actively used in the printer identification circuitry. In spite of the fact that a wire bond extends from the flexible circuit 35 to the contact pad 33, no circuit trace extends from the ID2 contact pad on the printhead. (It can be seen that a gap 46 is defined between the contact pad ID2 on the printhead so isolating the contact pad from any circuitry on the printhead.)

On the other hand, and referring to FIG. 3(b), the corresponding contact pad ID2 on the flexible circuit 35 is also isolated. In fact a circuit trace from the wire trace leading to the printhead contact pad ID2 is linked to the flexible circuit contact pad for R50 as indicated within the circle 47. This is because, while it was seen as beneficial to isolate the flexible circuit contact pad ID2 to mitigate potential problems caused by corrosion of the print head, this would have left the trace for ID2 on the flexible circuit open ended in the region of the contact pad for ID2. The end of the trace could then become prone to lifting and possibly causing the flexible circuit to fail. Thus, the trace for ID2 was linked to the trace for R50 to prevent such failure.

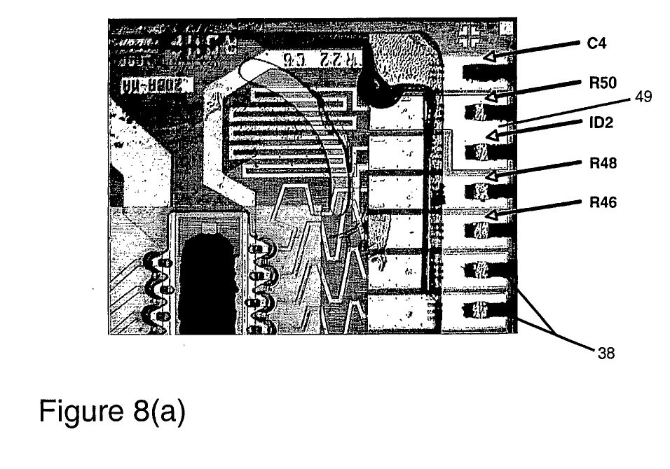

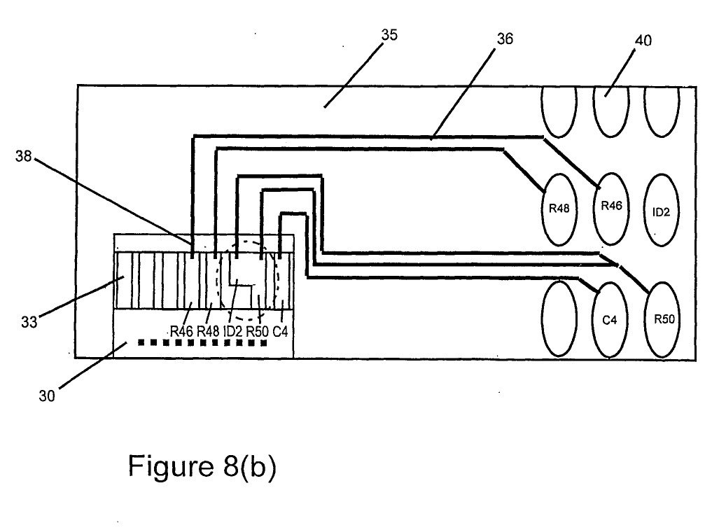

In a first embodiment of the present invention, the problems of the prior art are mitigated (e.g. in the case of model HP51649G printer cartridge) by joining the contact pads ID2 and R50 with a bridge portion 49 on the printhead to form one large ‘L shaped’ pad, FIG. 8(a).

As shown in the schematic diagram of FIG. 8(b), this means that the wire bonds linking the flexible circuit traces for contact pads ID2 and R50 form a parallel circuit linked back to the flexible sheet contact pad R50.

Ink will still penetrate encapsulant 39 as before, however, when the R50 wire bond corrodes, rather than the printer cartridge failing immediately, the adjoining pad adds a back-up wire bond to the identification circuitry.

Because the flexible circuit contact pad for ID2 is isolated there is no impact on this aspect of the printer identification circuitry.

The parallel circuit for R50 results in a change in resistance of approximately 0.15 ohm. Using a parallel circuit reduces current through each wire bond and it is thought that this in turn results in slower corrosion of the wire bonds.

It will be seen that the invention is applicable not alone to mitigating the problems of the particular cartridge of the first embodiment but also of other cartridges, in that if a redundant wire bond is available, and a contact pad for a portion of a circuit whose operation is critical to the operation of the circuit is prone to corrosion, then the contact pad connected to the redundant wire bond can be connected to the contact pad for the critical circuit to effectively form a single contact pad receiving two wire bonds. Thus, controlling circuitry can use traces extending from both wire bonds or link these traces (as in the preferred embodiment) in order to mitigate the problems of corrosion.

So in a second embodiment of the invention, which can be applied to the circuit shown in FIG. 6, the printhead contact for R50 is connected to the otherwise redundant (open circuit) printhead contact for ID1. The flexible circuit traces 36 are then designed to isolate the flexible circuit contact pad for ID1 (in the same manner as for the flexible circuit contact pad ID2 in FIG. 8(b)) and to connect the wire bond for ID1 via a trace to the flexible circuit contact pad for R50. Alternatively, the wire bond for ID1 could be used as a redundant circuit for the wire bond for the printhead contact pad R49. These solutions, however, may require re-engineering of both the printhead and the flexible circuit unlike in the first embodiment where only the printhead needs to be changed to implement the invention.

In the case of the printhead and flexible circuit designs of FIGS. 5 and 7 there are no immediately available redundant contact pads and so to implement the invention some more significant redesign of both the printhead and flexible circuit may be required to implement the invention. This may be done either by adding otherwise redundant contact pads to the printhead, each having an associated wire bond, or increasing the number of wire bonds for the given number of contact pads.

It will therefore be seen that the invention is applicable to the provision of additional wire bonds connecting a circuit (flexible or otherwise) to a die such as the printhead 30. This can be done either by employing improved processing capability to deploy an increased number of wire bonds within the same length of die or by increasing the size of a die so that it can accommodate more wire bonds and contact pads which can be used as redundant circuits to mitigate the problems of wire bond corrosion or even manufacturing defects or other post manufacturing faults.

It will be seen that the invention has a particular advantage in the field of printheads as it does not need to eliminate wire bond corrosion, rather it helps to delay the results of such corrosion at least until the printer cartridge is empty after which it usually becomes redundant anyway.

1. A printhead for a printer cartridge comprising a die including a plurality of nozzles and channels for admitting ink to said nozzles, a resistor network having a resistor at each nozzle, which resistor when energised heats and expels ink from the respective nozzle, said printhead including a set of contact pads, each resistor being connected by a trace to a respective contact pad of said set of contact pads, characterised in that one or more of said set of contact pads is adapted to receive more than one connection from a circuit external to said printhead.

2. A printhead as claimed in claim 1 wherein said printhead further includes printer cartridge identification circuitry associated with one or more contact pads of said set of contact pads.

3. A printhead as claimed in claim 1 wherein said one or more contacts comprises one contact directly connected to another otherwise redundant one of said set of contact pads within said printhead to receive two contacts from said external circuit.

4. A printhead as claimed in claim 2 wherein one of said one or more contact pads is connected to said printer cartridge identification circuitry.

5. A printhead as claimed in claim 4 wherein said contact pad connected to said printer cartridge identification circuitry is located towards a corner of said printhead.

6. A printhead as claimed in claim 3 wherein said connected contact pads are adjacent one another.

7. A printhead as claimed in claim 3 wherein one of said one or more contact pads is connected to circuitry critical to the operation of said printer cartridge.

8. A printer cartridge comprising a body incorporating one or more ink chambers in fluid communication with a printhead comprising a die including a plurality of nozzles and channels for admitting ink to said nozzles, a resistor network having a resistor at each nozzle, which resistor when energised heats and expels ink from the respective nozzle, said printhead including a set of contact pads, each resistor being connected by a trace to a respective contact pad of said set of contact pads, and a circuit affixed to said printer cartridge comprising a plurality of circuit traces, one end of at least some of said circuit traces being connected to respective contacts of said set of contact pads of said printhead and the other end of at least some of said circuit traces being arranged to, in use, connect to printer control circuitry characterised in that one or more of said set of contact pads is connected to more than one of said circuit traces.

9. A printer cartridge according to claim 8 wherein said printhead contact pads are connected to said circuit traces via wire bonds.

10. A printer cartridge as claimed in claim 8 wherein said more than one circuit traces are electrically connected within said circuit affixed to said printer cartridge to form a parallel circuit from the contact pad on the printhead to the circuit affixed to said printer cartridge.

11. A printer cartridge according to claim 9 wherein said wire bonds are covered with encapsulant.

12. A printer cartridge according to claim 8 wherein said circuit is a flexible circuit.

13. A printer cartridge according to claim 9 wherein the more than one wire bonds connecting a contact pad to respective circuit traces are disposed closer to one another than single wire bonds connecting a contact pad to a circuit trace.

14. A method of fabricating a printer cartridge comprising the steps of:
a. fabricating a body incorporating one or more ink chambers;
b. affixing a printhead to said body, said printhead comprising a die including a plurality of nozzles and channels for admitting ink from said chambers to said nozzles, a resistor network having a resistor at each nozzle, which resistor when energised heats and expels ink from the respective nozzle, said printhead including a set of contact pads, each resistor being connected by a trace to a respective contact pad of said set of contact pads;
c. affixing a circuit to said printer cartridge, said circuit comprising a plurality of circuit traces, one end of at least some of said circuit traces being arranged to, in use, connect to printer control circuitry; and
d. connecting the other end of at least some of said circuit traces to respective contacts of said set of contact pads characterised in that one or more of said set of contact pads is connected to more than one of said circuit traces.
